(19) United States
(12) Patent Application Publication
(10) Pub. No.: US 2025/0174805 A1
(43) Pub. Date: May 29, 2025

(54) BATTERY MODULE

(71) Applicant: TOYOTA JIDOSHA KABUSHIKI KAISHA, Aichi-ken (JP)

(72) Inventor: Kota ICHISAWA, Toyota-shi (JP)

(21) Appl. No.: 18/953,071

(22) Filed: Nov. 20, 2024

(30) Foreign Application Priority Data
Nov. 29, 2023 (JP) 2023-202156

(51) Int. Cl. H01M 50/291; H01M 50/209; H01M 50/227; H01M 50/238; H01M 50/293

(52) U.S. Cl. CPC H01M 50/291; H01M 50/227; H01M 50/238; H01M 50/293; H01M 50/209

(57) ABSTRACT

A battery module includes a laminate having a plurality of battery cells and resin frames. Further, the resin frame includes a separator portion sandwiched between the battery cells in a stacking direction, a tapered portion, provided outside an edge of the battery cell, protruding from the separator portion, and inclined to a center axis side of the laminate, and a guide portion, provided outside the edge of the battery cell, projecting from the separator portion towards another side, and the tapered portion is in contact with the guide portion in a state of being inserted into the guide portion of the resin frame adjacent to the tapered portion to receive a load acting on the central axis side from the guide portion when the laminate is compressed in the stacking direction.

### CROSS-REFERENCE TO RELATED APPLICATION(S)

The present application claims priority to and incorporates by reference the entire contents of Japanese Patent Application No. 2023-202156 filed in Japan on Nov. 29, 2023.

### BACKGROUND

The present invention relates to a battery module.

Japanese Laid-open Patent Publication No. 2022-125550 discloses a battery module in which a plurality of battery cells and a plurality of separators are stacked, and pressure and release in the stacking direction during stacking, pressure and pressure release in the orthogonal direction perpendicular to the stacking direction repeatedly to position the battery cell.

### SUMMARY

There is a need for providing a battery module capable of suppressing the positional deviation of the battery cells in the structure in which a plurality of battery cells are stacked.

According to an embodiment, a battery module includes a laminate in which a plurality of battery cells and a plurality of resin frames are alternately stacked. Further, the resin frame includes a separator portion sandwiched between the battery cells adjacent to each other in a stacking direction of the laminate, a tapered portion, provided outside an edge of the battery cell in a direction perpendicular to the stacking direction, protruding from the separator portion towards one side of the stacking direction, and inclined to a center axis side of the laminate with respect to the stacking direction, and a guide portion, provided outside the edge of the battery cell in the orthogonal direction, projecting from the separator portion towards another side of the stacking direction, and the tapered portion is in contact with the guide portion in a state of being inserted into the guide portion of the resin frame adjacent to the tapered portion to receive a load acting on the central axis side from the guide portion when the laminate is compressed in the stacking direction.

### BRIEF DESCRIPTION OF THE DRAWINGS

FIG. 1 is a schematic diagram illustrating a battery module according to an embodiment;

FIG. 2 is a diagram for explaining the structure of a laminate;

FIG. 3 is a diagram schematically illustrating a structure of the battery cell and the resin frame;

FIG. 4 is a diagram schematically illustrating a structure of the resin frame;

FIG. 5 is a diagram for explaining a case where the resin frame is constituted by a thin frame and a thick frame.

### DETAILED DESCRIPTION

In the configuration described in Japanese Laid-open Patent Publication No. 2022-125550, since there is no surface suppression in a direction perpendicular to the stacking direction to the battery cell during the process of finally pressurizing to the stacking direction, eventually there is a possibility that the battery cell is displaced position in the height direction and the width direction.

Hereinafter, a battery module in the embodiment of the present invention will be specifically described. Note that the present invention is not limited to the embodiments described below.

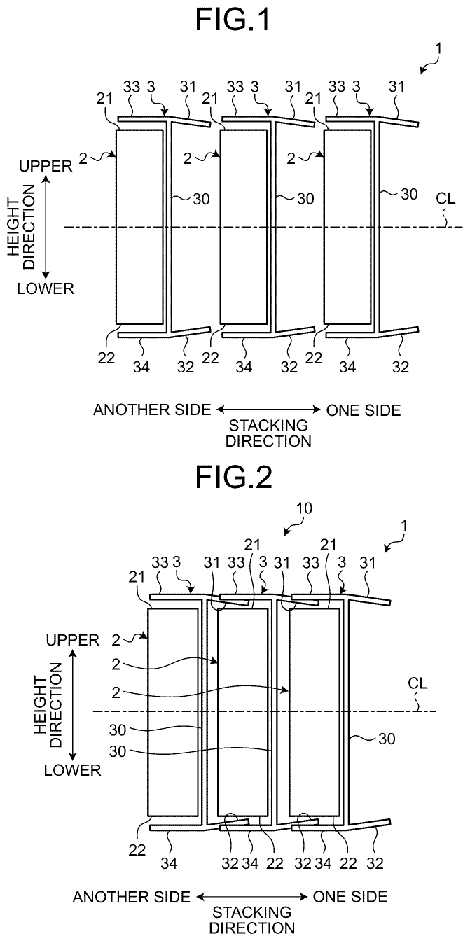

FIG. 1 is a schematic diagram showing a battery module in the embodiment. A battery module 1 includes a plurality of battery cells 2, a plurality of resin frame 3. As illustrated in FIG. 2, the battery module 1 includes a laminate 10 in which a plurality of battery cells 2 and a plurality of resin frame 3 are alternately stacked. In the following description, the resin frame 3 is simply described as the frame 3.

The battery cell 2 is constituted by a secondary battery such as a lithium ion battery. The battery cell 2 is a square cell. The frame 3 is provided so as to surround the square-shaped edge of the battery cell 2. As illustrated in FIG. 1, the laminated body 10 is constituted by a set of components in which one battery cell 2 and one frame 3 are integrated by stacking a plurality in the stacking direction. That is, as a set of components, one battery cell 2 to one frame 3 is in a state of being fixed.

The frame 3 is an insulating separator disposed between the battery cells 2 adjacent to each other in the stacking direction. The frame 3 is formed in a rectangular shape in accordance with the shape of the battery cell 2.

In the battery module 1, by providing the tapered portion on the outer peripheral portion of the frame 3, the tapered portion of the frame 3 adjacent using a compressive load when compressing the laminate 10 in the stacking direction is configured to align itself. The battery module 1 has an axis alignment guide structure during lamination pressurization by applying a tapered shape to the frame 3.

Specifically, the frame 3 has a separator portion 30 sandwiched between the battery cells 2 adjacent in the stacking direction of the laminate 10, and a tapered portion and a guide portion which is integrally molded with the separator portion 30. The tapered portion is a portion inclined toward the central axis CL of the laminate 10 with respect to the stacking direction. The tapered portion is provided outside the edge of the battery cell 2 in a direction perpendicular to the stacking direction, a portion projecting from the separator portion 30 on one side of the stacking direction. The guide portion is provided on the outer side than the edge of the battery cell 2 in a direction perpendicular to the stacking direction, a portion projecting from the separator portion 30 on the other side of the stacking direction. The tapered portion is in contact with the guide portion while being inserted into the guide portion of the frame 3 adjacent to receive a load acting on the central axis CL from the guide portion by the laminate 10 is compressed in the stacking direction. In the following description, the orthogonal direction perpendicular to the stacking direction is simply described as the orthogonal direction. Further, the orthogonal direction includes a height direction and a width direction.

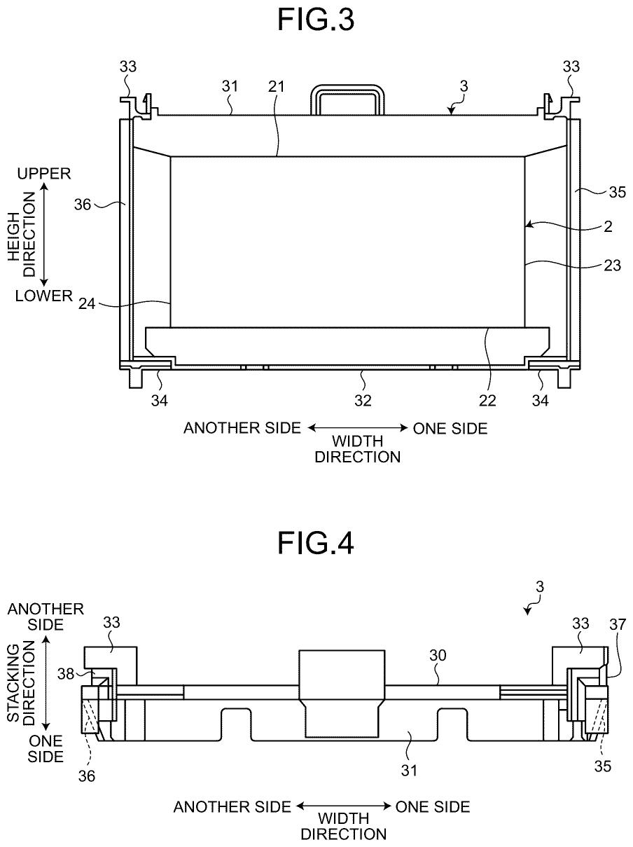

The frame 3, as illustrated in FIGS. 1 to 4, the separator portion 30, an upper tapered portion 31, a lower tapered portion 32, an upper guide portion 33, a lower guide portion 34, one side tapered portion 35, the other side tapered portion 36, one side guide portion 37, and the other side guide portion 38. The tapered portion of the frame body 3 includes an upper tapered portion 31 and the lower tapered portion 32 and one side tapered portion 35 and the other side tapered portion 36. The guide portion of the frame 3 includes an upper guide portion 33 and the lower guide portion 34 and one side guide portion 37 and the other side guide portion 38.

The separator portion 30 is a plate-like portion disposed between the adjacent battery cells 2 in the stacking direction of the stack 10. The separator portion 30 has an opposing surface facing the battery cell 2 in the stacking direction. The separator portion 30 is formed in a slightly larger square shape than the surface of the stacking direction side of the battery cell 2.

The upper tapered portion 31 is provided above the upper edge 21 of the battery cell 2 in the height direction of the stack 10, projecting from the upper portion of the separator portion 30 on one side in the stacking direction. As illustrated in FIGS. 1 and 2, the upper tapered portion 31 is inclined to the lower height toward the central axis CL from the upper portion of the separator portion 30. The upper tapered portion 31 is formed in a range of a predetermined width in the width direction of the laminate 10. For example, the upper tapered portion 31 is provided in a range including at least the width direction both end sides of the frame 3.

The lower tapered portion 32 is provided on the lower side of the lower edge 22 of the battery cell 2 in the height direction of the stack 10, projecting from the lower portion of the separator portion 30 on one side of the stacking direction. As illustrated in FIGS. 1 and 2, the lower tapered portion 32 is inclined to the upper height toward the central axis CL from the lower portion of the separator portion 30. The lower tapered portion 32 is formed in a range of a predetermined width in the width direction of the laminate 10. For example, the lower tapered portion 32 is provided in a range including at least the width direction both end sides of the frame 3. Rigidity of the lower tapered portion 32 is configured to the same size as the rigidity of the upper tapered portion 31.

The upper guide portion 33 is a guide portion where the upper tapered portion 31 of the frame 3 adjacent thereto is inserted. The upper guide portion 33 is provided above the upper edge 21 of the battery cell 2 in the height direction, projecting from the upper portion of the separator portion 30 on the other side in the stacking direction. The upper guide portion 33 extends parallel to the stacking direction. The upper guide portion 33 is formed at a position corresponding to the upper tapered portion 31 in the width direction of the stack 10. For example, the upper guide portion 33 is provided in a range including at least the width direction both end sides of the frame 3. The upper tapered portion 31 abuts against the lower surface of the upper guide portion 33 in a state of being inserted into the upper guide portion 33.

The lower guide portion 34 is a guide portion where the lower tapered portion 32 of the frame 3 adjacent thereto is inserted. The lower guide portion 34 is provided below the lower edge 22 of the battery cell 2 in the height direction, projecting from the lower portion of the separator portion 30 on the other side in the stacking direction. The lower guide portion 34 extends parallel to the stacking direction. The lower guide portion 34 is formed at a position corresponding to the lower tapered portion 32 in the width direction of the laminate 10. For example, the lower guide portion 34 is provided in a range including at least the width direction both end sides of the frame 3. The lower tapered portion 32 abuts the upper surface of the lower guide portion 34 in a state of being inserted into the lower guide portion 34. Rigidity of the lower guide portion 34 is configured to the same size as the rigidity of the upper guide portion 33.

In the frame 3 adjacent thereto, the lower load in the height direction from the upper guide portion 33 to the upper tapered portion 31 by the laminate 10 is compressed in the stacking direction acts, and the upper load in the height direction from the lower guide portion 34 to the lower tapered portion 32 acts. Thus, the load acting on the central axis CL by utilizing the compressive load in the stacking direction can be aligned in the height direction of the cell 2.

One side tapered portion 35 is provided on the outside of the one side edge 23 of the battery cell 2 on one side of the width direction of the stack 10, projecting from the end of the separator portion 30 on one side of the stacking direction. As illustrated in FIG. 4, one side tapered portion 35 is inclined to the other side in the width direction toward the central axis CL from the end of the separator portion 30. One side tapered portion 35 is a vertical wall portion formed on one side in the width direction of the frame 3. On one side in the width direction of the frame 3, one side tapered portion 35 is formed over the entire height direction of the frame 3.

The other side tapered portion 36 is provided on the outside of the other side edge 24 of the battery cell 2 on the other side of the width direction of the stack 10, projecting from the end of the separator portion 30 on one side of the stacking direction. As illustrated in FIG. 4, the other side tapered portion 36 is inclined to one side of the width direction toward the central axis CL from the end of the separator portion 30. The other side tapered portion 36 is a vertical wall portion formed on the other side in the width direction of the frame 3. On the other side in the width direction of the frame 3, the other side tapered portion 36 is formed over the entire height direction of the frame 3. Rigidity of the other side tapered portion 36 is configured to the same size as the rigidity of the one side tapered portion 35.

One side guide portion 37 is a guide portion which one side tapered portion 35 of the adjacent frame 3 is inserted. One side guide portion 37 is provided on the outside of the one side edge 23 of the battery cell 2 on one side of the width direction, projecting from the end of the separator portion 30 on one side of the stacking direction. One side guide portion 37 extends parallel to the stacking direction. One side guide portion 37 is formed at a position corresponding to one side tapered portion 35 in the height direction of the laminate 10. For example, in the width direction one side of the frame 3, one side guide portion 37 is formed over the entire height direction of the frame 3. One side tapered portion 35 abuts on the inner surface of the one side guide portion 37 in a state of being inserted into the one side guide portion 37.

The other side guide portion 38 is a guide portion other side tapered portion 36 of the frame 3 adjacent is inserted. The other side guide portion 38 is provided on the outside of the other side edge 24 of the battery cell 2 on the other side of the width direction, projecting from the end of the separator portion 30 on one side of the stacking direction. The other side guide portion 38 extends parallel to the stacking direction.

The other side guide portion 38 is formed at a position corresponding to the other side tapered portion 36 in the height direction of the laminate 10. For example, on the other side in the width direction of the frame 3, the other side guide portion 38 is formed over the entire height direction of the frame 3. The other side tapered portion 36 abuts against the inner surface of the other side guide portion 38 in a state of being inserted into the other side guide portion 38. Rigidity of the other side guide portion 38 is configured to the same size as the rigidity of the one side guide portion 37.

In the adjacent frame 3, the lower load in the height direction from the upper guide portion 33 to the upper tapered portion 31 by the laminate 10 is compressed in the stacking direction acts, and the upper load in the height direction from the lower guide portion 34 to the lower tapered portion 32 acts. Thus, the load acting on the central axis CL by utilizing the compressive load in the stacking direction can be aligned in the height direction of the cell 2.

As described above, according to the embodiment, since the tapered portion by pressure when compressing the laminate 10 in the stacking direction has a structure that interferes with the guide portion, the laminate 10 by this interference can perform axis alignment itself.

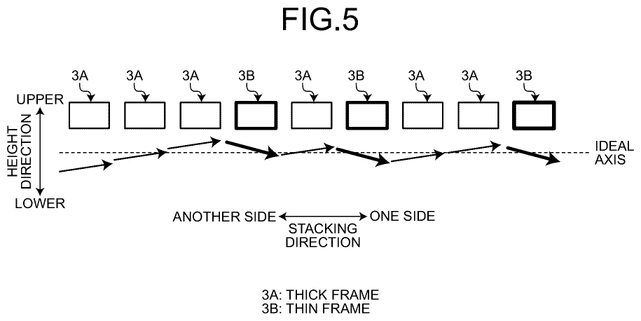

Further, in the frame 3, the rigidity of the upper tapered portion 31 and the rigidity of the lower tapered portion 32 can be configured to different sizes. The upper tapered portion 31 and the lower tapered portion 32 have different rigidities by providing ribs in the tapered portion to increase rigidity or by changing the wall thickness of the tapered portion. For example, the frame 3 rigidity of the upper tapered portion 31 is configured to be lower than the rigidity of the lower tapered portion 32 and a thin frame 3A, the rigidity of the upper tapered portion 31 is configured to be higher than the rigidity of the lower tapered portion 32 frame 3 and the thick frame 3B. In this instance, as shown in FIG. 5, by the laminate 10 laminated thin frame 3A and the thick frame 3B at a predetermined ratio, thereby enabling cancellation of axial misalignment due to stiffness differences. Thus, it is possible to absorb the total length variation of the laminate 10.

Further, in the frame 3, similarly to the upper tapered portion 31 and the lower tapered portion 32, it is possible to configure the rigidity of the one-side tapered portion 35 and the rigidity of the other-side tapered portion 36 to different sizes.

According to an embodiment, it is possible to suppress the positional deviation of the battery cells in the structure in which a plurality of battery cells are stacked.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A battery module comprising a laminate in which a plurality of battery cells and a plurality of resin frames are alternately stacked, wherein
the resin frame includes
a separator portion sandwiched between the battery cells adjacent to each other in a stacking direction of the laminate,
a tapered portion, provided outside an edge of the battery cell in a direction perpendicular to the stacking direction, protruding from the separator portion towards one side of the stacking direction, and inclined to a center axis side of the laminate with respect to the stacking direction, and
a guide portion, provided outside the edge of the battery cell in the orthogonal direction, projecting from the separator portion towards another side of the stacking direction, and
the tapered portion is in contact with the guide portion in a state of being inserted into the guide portion of the resin frame adjacent to the tapered portion to receive a load acting on the central axis side from the guide portion when the laminate is compressed in the stacking direction.

2. The battery module according to claim 1, wherein
the tapered portion includes:
an upper tapered portion provided above an upper edge of the battery cell in a height direction of the laminate, and
a lower tapered portion provided below a lower edge of the battery cell in the height direction,
the guide portion includes:
an upper guide portion to which the upper tapered portion is inserted, and
a lower guide portion to which the lower tapered portion is inserted, and
in the resin frames adjacent to each other, when the laminate is compressed in the stacking direction, a load towards a lower side in the height direction acts from the upper guide portion to the upper tapered portion, and a load towards an upper side in the height direction acts from the lower guide portion to the lower tapered portion.

3. The battery module according to claim 2, wherein
a rigidity of the upper tapered portion is different from the rigidity of the lower tapered portion.

4. The battery module according to claim 2, wherein
the tapered portion includes:
a one side tapered portion provided outside of a one side edge of the battery cell in a width direction of the laminate, and
an another side tapered portion provided outside of another side edge of the battery cell in the width direction,
the guide portion includes:
a one side guide portion to which the one side tapered portion is inserted, and
an another side guide portion to which the another side tapered portion is inserted, and
in the resin frames adjacent to each other, when the laminate is compressed in the stacking direction, a load towards an another side in the width direction acts from the one side guide portion to the one side tapered portion, and a load towards a one side in the width direction acts from the another side guide portion to the another side tapered portion.

5. The battery module according to claim 4, wherein
a rigidity of the one side tapered portion is different from the rigidity of the lower tapered portion.
